(19) United States
(12) Patent Application Publication
(10) Pub. No.: US 2016/0255445 A1
(43) Pub. Date: Sep. 1, 2016

(54) DIRECTIONAL MICROPHONE MODULE

(71) Applicant: Sonion Nederland B.V., Hoofddorp (NL)

(72) Inventors: Adrianus Maria Lafort, Delft (NL); Andreas Tiefenau, Koog a/d Zaan (NL); Anne-Marie Sänger, Koog a/d Zaan (NL); Arkadiusz Wasylków, Amsterdam (NL); Dion Ivo de Roo, Voorburg (NL)

(21) Appl. No.: 15/019,533

(22) Filed: Feb. 9, 2016

(30) Foreign Application Priority Data
Feb. 10, 2015 (EP) 15154472.3

(51) Int. Cl. H04R 25/00

(52) U.S. Cl. CPC H04R 25/405; H04R 25/407

(57) ABSTRACT

The present invention relates to a microphone module comprising at least two directional microphones having different polar patterns and a single front sound inlet and a single rear sound inlet. The present invention provides a compact and space saving microphone module being less sensitive for mismatch or drift between the applied directional microphones and thereby very robust in directional performance. The microphone module of the present invention is, in particular, suitable in relation to hearing aid applications. The present invention further relates to an associated method for handling and processing signals from the at least two directional microphones.

### CROSS-REFERENCE TO RELATED APPLICATION

This application claims the benefit of European Patent Application Serial No. 15154472.3, filed Feb. 10, 2015, and titled “Directional Microphone Module,” which is incorporated herein by reference in its entirety.

### FIELD OF THE INVENTION

The present invention relates to a microphone module comprising at least two directional microphones. In particular, the present invention relates to a microphone module which is less sensitive for mismatch or drift between the applied directional microphones and thereby very robust in directional performance.

### BACKGROUND OF THE INVENTION

Various techniques to achieve directional hearing in a hearing aid have been suggested over the years. Examples of such techniques are as follows:

Matched pair of two omni-directional microphones: Directional hearing in hearing aids may be achieved by the use of a matched pair of two omni-directional microphones. To generate a directional output signal the signals from the omni-directional microphones are subtracted. An electrical time delay may be applied to one of the signals to shift the notch angle of the polar pattern. It is a disadvantage of the matched pair that in case of a mismatch/drift the directivity degrades heavily, in particular in the low frequency ranges. Moreover, matching microphones as well as amplitude/phase correction in the hearing aid production are time consuming manual operations.

Analogue directional microphone: Directional hearing in a hearing aid may also be achieved by the use of an analogue directional microphone. An analogue directional microphone is a microphone with one sound port in the front and one sound port in the rear volume. The advantage of an analogue directional microphone is that directionality cannot be degraded by drift or mismatch. However, the notch angle is at a fixed position and cannot be shifted by processing for beam forming purposes.

WO 2012/139230 discloses PU microphone module consisting of one omni-directional microphone (P) and one analogue directional microphone (U). The microphone module has two ports. The directional microphone picks up the pressure difference between front and rear port. In one embodiment the omni-directional microphone picks up the pressure at the front port of the module. Another embodiment is that the omni-directional microphone picks up the average of the pressures at front and rear port. The advantage of the PU microphone module is that the directional output is robust to compensate for mismatch/drift because it makes use of an analogue directional microphone which has a stable notch at 90 degree. The closer the desired notch angle is to 90 degree the smaller the impact of mismatch/drift on directionality. However, for notch angles close to 180 degree mismatch/drift still have a significant impact on directionality.

The so-called Jacobian module, cf. for example U.S. Pat. No. 8,254,609 comprises two directional microphones and one omni-directional microphone. The main advantage of the Jacobian principle is that a higher order directionality can be obtained. However, it is a disadvantage that the two directional microphones need to be matched very tightly. In case of mismatch/drift the directivity of the module degrades heavily.

Finally, the Blumlein pair is a stereo recording technique (also known as M/S technique) that makes use of two directional microphones. One of the directional microphones has a cardioid polar pattern (notch at 180 degree) and the other one is a dipole (notch at 90 degree). The microphones are oriented in a 90 degree angle towards each other. It is disadvantage of the Blumlein pair that it is a rather bulky design that requires a significant amount of space.

It may be seen as an object of embodiments of the present invention to provide a compact and space saving microphone module comprising a plurality of directional microphones, said microphone module being less sensitive for mismatch or drift between the applied directional microphones and thereby very robust in directional performance.

### SUMMARY OF INVENTION

The above-mentioned object is complied with by providing, in a first aspect, a microphone module comprising

1) at least two directional microphones having different polar patterns, and

2) a single front sound inlet and a single rear sound inlet.

It is an advantage of the microphone module of the present invention that it, compared to known directional techniques used in hearing aids, is less sensitive to mismatch or drift between the applied microphones.

The main difference between the microphone module of the present invention compared to the Blumlein pair is that the directional axes of the at least two directional microphones coincide while in the Blumlein pair they are oriented in an angle of 90 degree. Coinciding directional axes make it possible to share volumes/sound inlets, i.e. manufacturing a more compact hearing aid microphone module.

The at least two directional microphones of the microphone module of the present invention may include various types of microphones, such as analogue microphones.

In addition to the at least two directional microphones the microphone module of the present invention further comprises the single front sound inlet and the single rear sound inlet in order to allow sound pressures to enter respective front and rear volumes of the directional microphones.

The at least two directional microphones may share a common microphone module housing or cabinet. This sharing of a common microphone module housing or cabinet is advantageous in that it significantly simplifies the mechanical construction of the microphone module. By incorporating the directional microphones into a common microphone module housing or cabinet individual microphone housings or cabinets may be omitted.

The front sound inlet may be acoustically connected to either a common front volume of the directional microphones or to separated front volumes of the directional microphones. The front sound inlet may be acoustically connected to the common front volume or the separated front volumes via one or more acoustical resistances. Such acoustical resistances ensure that appropriate acoustical delays may be introduced in a given acoustical path. As an example grids may be used as acoustical resistances.

The rear sound inlet may be acoustically connected to either separated rear volumes of the directional microphones or to one of acoustically connected rear volumes of the directional microphones. The rear volumes may be acoustically connected via one or more acoustical resistances, such as grids. The rear sound inlet may be acoustically connected to the separated rear volumes or to one of the acoustically connected rear volumes via one or more acoustical resistances, such as grids.

The at least two directional microphones of the microphone module may comprise a first directional microphone having an essential cardioid polar pattern, and a second directional microphone having an essential dipole shaped polar pattern.

The dipole and cardioid shaped polar patterns are both well-defined polar patterns. It is thus well-established that the cardioid polar pattern has a notch at 180 degree, whereas the dipole polar pattern has a notch at 90 degree.

Alternatively, the microphone module may comprise a first directional microphone having an essential cardioid polar pattern, and a second directional microphone having an essential hypercardioid shaped polar pattern. In combination therewith a third directional microphone having an essential dipole shaped polar pattern may optionally be provided.

In a first embodiment the at least two directional microphones may share a common front volume. Moreover, the rear volumes of the directional microphones may be connected via one or more acoustical resistances, such as grids. Additionally, the acoustical connection between the rear sound inlet and one of the acoustically connected rear volumes may be implemented by means of one or more acoustical resistances, such as grids. Sharing volumes (front and/or rear) obviously saves space but it also leads to acoustic coupling of the membranes of the applied directional microphones. Acoustic coupling of membranes generally compromises the directional performance of the module. In a second embodiment the at least two directional microphones may have separated front and separated rear volumes. The acoustical connection between the rear sound inlet and the rear volumes may comprise one or more acoustical resistances, such as grids. Similarly, the acoustical connection between the front inlet and the separated front volumes may comprise one or more acoustical resistances, such as grids. If the applied directional microphones do not share common front/rear volumes the directional performance of the microphone module is not compromised by acoustic coupling of the membranes.

In a third embodiment the at least two directional microphones may have separated front and acoustically connected rear volumes. The acoustical connection between the rear sound inlet and one of the rear volumes may comprise one or more acoustical resistances, such as grids. Similarly, the acoustical connection between the front inlet and the separated front volumes may comprise one or more acoustical resistances, such as grids. This embodiment is a compromise between saving space by sharing the rear volumes and reducing acoustic coupling of the membranes by separating the front volumes.

In a fourth embodiment the at least two directional microphones share a common front volume and have separated rear volumes. The acoustical connection between the rear sound inlet and the separated rear volumes may comprise one or more acoustical resistances, such as grids. Also, the acoustical connection between the front inlet and the common front volume may comprise one or more acoustical resistances, such as grids. This embodiment is a compromise between saving space by sharing the front volumes and reducing acoustic coupling of the membranes by separating the rear volumes.

The microphone module of the present invention may further comprise at least one omni-directional microphone having a separated rear volume. However, the at least two directional microphones and at least one omni-directional microphone may share a common front volume.

In a second aspect the present invention relates to a hearing aid comprising a microphone module according to the first aspect of the present invention.

In a third and final aspect the present invention relates to a method for processing signals in a microphone module according to the first aspect, the method comprising the step of combining respective output signals from the at least two directional microphones.

According to this method a robust directional signal may be generated by weighted summation of the output signals from the at least two directional microphones. To give an example for a microphone module having a cardioid and a dipole output signal: If the weights for a first and a second microphone are both +1 (no amplification) the notch angle of the resulting output signal will be at 120 degree. By amplifying the output signal of the first directional microphone (weight of the cardioid output higher than +1) the notch angle of the resulting output signal will be higher than 120 degree. By amplifying the output signal of the second directional microphone (weight of the dipole output higher than +1) the notch angle of the resulting output signal will be lower 120 degree.

### BRIEF DESCRIPTION OF THE DRAWINGS

The present invention will now be explained with reference to the accompanying figures where

FIG. 1 shows a dipole polar pattern, a cardioid polar pattern and the sum of dipole and cardioid polar pattern (weights for first and second microphone are both +1),

FIG. 2a and FIG. 2b both show shows microphone modules having shared front volumes and connected rear volumes,

FIG. 3 shows a microphone module having separated front and rear volumes,

FIG. 4 shows a microphone module including an omni-directional microphone,

FIG. 5a shows a microphone module with connected rear volumes and FIG. 5b shows a microphone module with shared front volume, and

FIG. 6 shows a microphone module with three directional microphones.

While the invention is susceptible to various modifications and alternative forms specific embodiments have been shown by way of examples in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF PREFERRED EMBODIMENTS

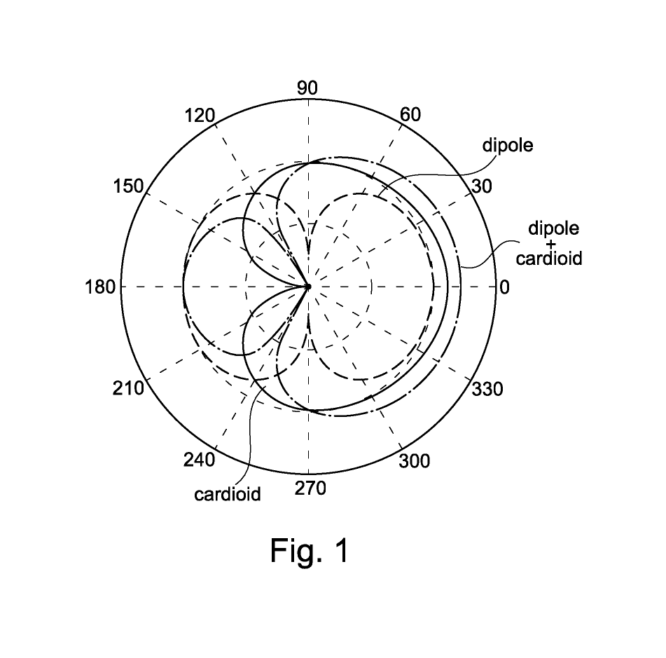

In its broadest aspect the present invention relates to a microphone module comprising at least two directional microphones, such as two analogue directional microphones, i.e. a so-called UU microphone module. One of the directional microphones may have a dipole polar pattern (notch at 90 degree), whereas the other directional microphone may have a cardioid polar pattern (notch at 180 degree), cf. FIG. 1. The cardioid polar pattern can be created by adding acoustical resistance between a membrane and one of the sound inlets of the particular directional microphone. The acoustical resistance may be implemented by varying means, such as for example a grid.

Alternatively, one of the directional microphones may have a cardioid polar pattern, whereas the other directional microphone may have a hypercardioid polar pattern.

In the following the present invention will be described with reference to a microphone module having a directional microphone having a dipole polar pattern and another directional microphone having cardioid polar pattern.

The directional microphones of the present invention share the same front and rear sound inlet or even the same front and rear volumes. Sharing sound inlets and/or volumes (front and/or rear) obviously saves space. Therefore the UU microphone module of the present invention may be considered as an effective way to make a robust directional microphone module that consumes as little space as possible.

The advantage of the UU microphone module is that the directional output is even more robust to mismatch/drift compared to the PU microphone module. For comparison and as previously mentioned the PU microphone module comprises an omni-directional microphone (P) and a directional microphone (U) with a stable notch at 90 degree. The microphone module of the present invention has two stable notches: one at 90 and another one at 180 degree.

Therefore, also for desired notch angles close to 180 degree the microphone module of the present invention is very stable. Moreover, notches at angles between 90 and 180 degrees are also more stable compared to the PU microphone module.

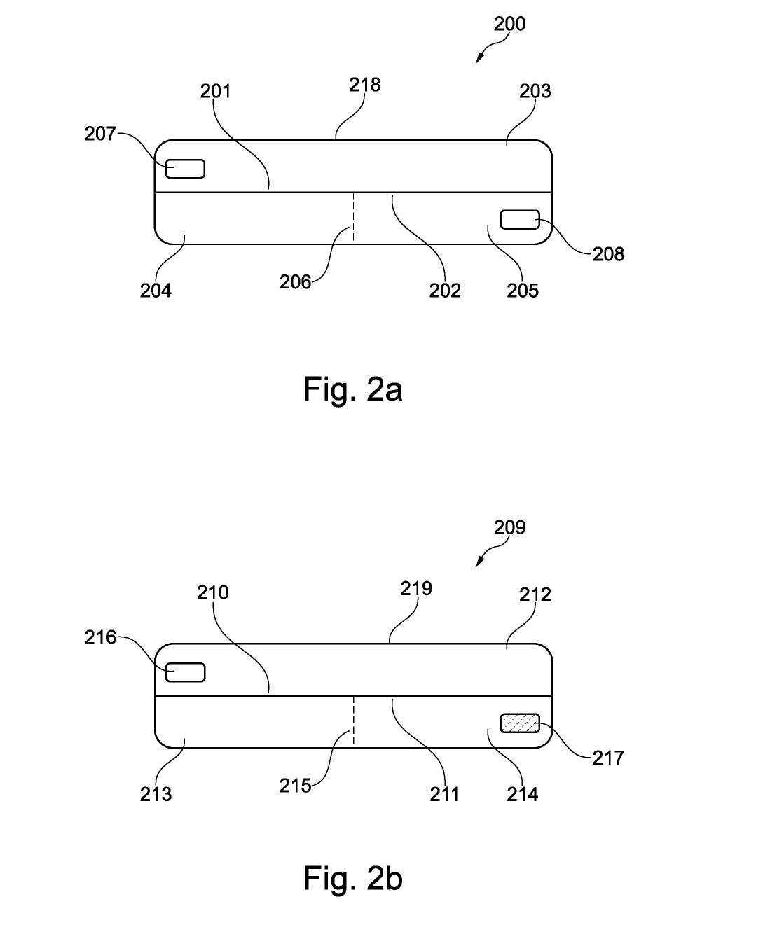

Referring now to FIG. 2a a first embodiment 200 comprising two directional microphones with associated membranes 201, 202 sharing the same front 203 and rear volumes 204, 205 are depicted. Membrane 201 generates the cardioid output, whereas membrane 202 generates the dipole output. The rear volumes 204, 205 are connected by means of an acoustical resistance 206. The acoustical resistance may be implemented as a grid. A front sound inlet 207 and a rear sound inlet 208 are in acoustical connection with the front 203 and rear 205 volumes, respectively. The microphone module 200 has a common outer housing or cabinet 218 which is shared by the two directional microphones whereby individual microphone housings or cabinets can be omitted.

Referring now to FIG. 2b a second embodiment 209 comprising two directional microphones with associated membranes 210, 211 sharing the same front volume 212. The connected rear volumes 213, 214 are depicted. Membrane 210 generates the cardioid output, whereas membrane 211 generates the hypercardioid output. The rear volumes 213, 214 are connected by means of an acoustical resistance 215. The acoustical resistance may be implemented as a grid. A front sound inlet 216 and a rear sound inlet 217 including a grid are in acoustical connection with the front 212 and rear 214 volumes, respectively. Again, the two directional microphones share the same outer housing or cabinet 219.

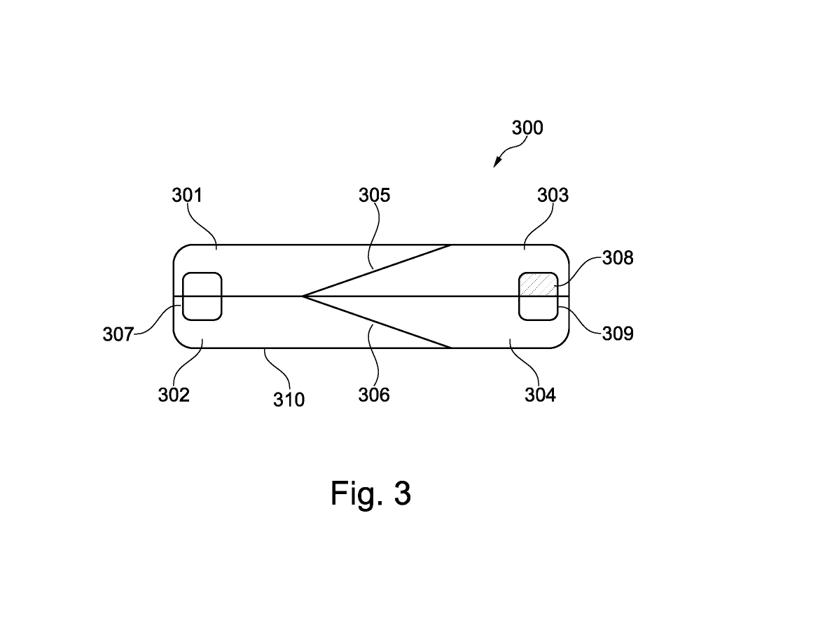

Referring now to FIG. 3 a second embodiment of the present invention is depicted. According to this embodiment in the microphone module 300 the two directional microphones have separate front volumes 301, 302 and separate rear volumes 303, 304. Membrane 305 generates the cardioid output, whereas membrane 306 generates the dipole output. A shared front sound inlet 307 is acoustically connected to the front volumes 301, 302 whereas a shared rear sound inlet 308, 309 is acoustically connected to respective rear volumes 303, 304. Part of the shared rear sound inlet 308 comprises an acoustical resistance in the form of a grid in the acoustical connection to the rear volume 303. Similar to FIG. 2 the two directional microphones share the same outer housing or cabinet 310.

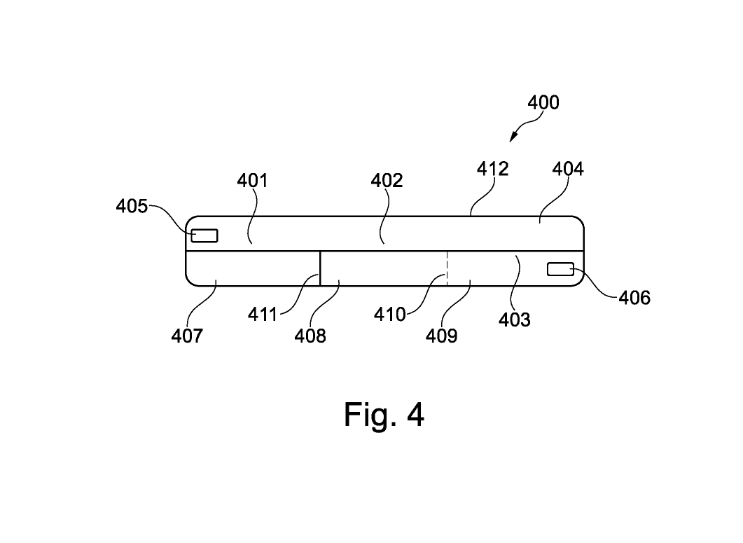

The first and second embodiments of the present invention have no useful omni-directional output because subtracting a cardioid and a dipole output from each other will lead to an omni-directional output having a poor sensitivity, in particular in the low frequency range. Therefore, an omni-directional microphone (P) may optionally be added as illustrated in FIG. 4.

FIG. 4 shows how an omni-directional microphone comprising membrane 401 may be incorporated into the UU microphone module 400 of the present invention. In FIG. 4 the membrane 401 generates the omni-directional output, membrane 402 generates the cardioid output, whereas membrane 403 generates the dipole output. The three microphones share the same front volume 404, said front volume being acoustically connected to front sound inlet 405. In FIG. 4 the three microphones share the same outer housing or cabinet 412.

A rear sound inlet 406 is acoustically connected to the rear volume 409 which is connected to rear volume 408 by an acoustical resistance 410 optionally in the form of a grid. Rear volumes 408, 409 are physically separated from rear volume 407 by a rigid wall 411.

Alternatively, it is also possible to use a separate omni-directional microphone to have more freedom in designing the hearing aid.

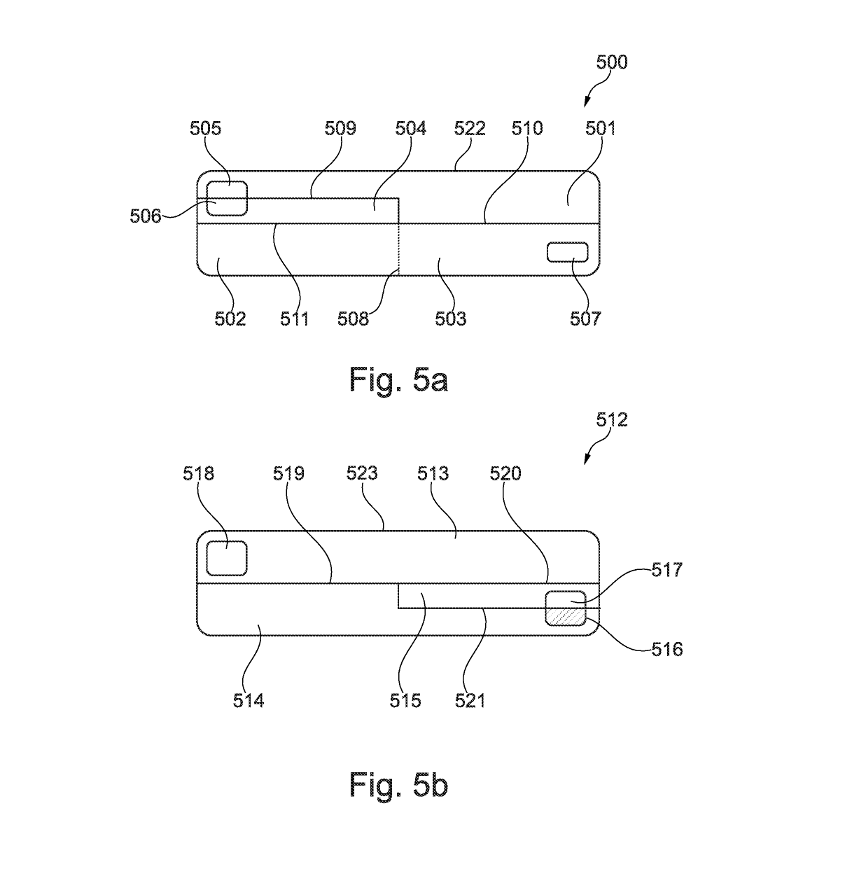

FIG. 5a shows an embodiment 500 having connected rear volumes 502, 503 and separated front volumes 501, 504. The front volumes 501, 504 are acoustically separated by a rigid wall 509. The rear volumes 502, 503 are connected by an acoustical resistance in the form of a grid 508. The front sound inlet is divided in two inlets 505, 506. Sound inlet 505 is acoustically connected to front volume 501, whereas sound inlet 506 is acoustically connected to front volume 504. A rear sound inlet 507 is acoustically connected to rear volume 503. The front volumes 501, 504 are separated from the rear volumes 502, 503 by membranes 510 and 511. The microphones of FIG. 5a share the same outer housing or cabinet 522.

In FIG. 5b an embodiment 512 having a shared front volume 513 and separated rear volumes 514, 515 is depicted. The rear volumes 514, 515 are acoustically separated by a rigid wall 521. The rear sound inlet is divided in two inlets 516, 517. Sound inlet 517 is acoustically connected to rear volume 515, whereas inlet 516 is acoustically connected to rear volume 514 via acoustical resistance means, such as a grid. A front sound inlet 518 is acoustically connected to front volume 513. The front volume 513 is separated from the rear volumes 514, 515 by membranes 519 and 520. Similar to FIG. 5a, the microphones of FIG. 5b share the same outer housing or cabinet 523.

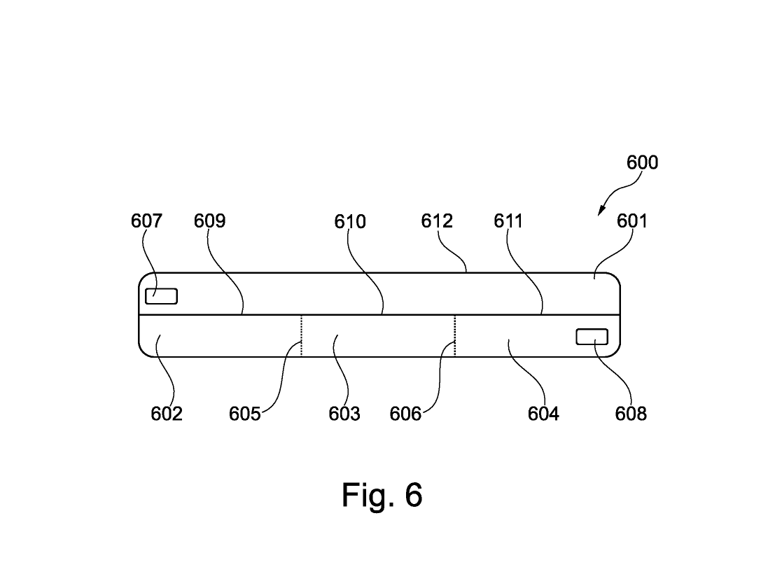

FIG. 6 shows a microphone module 600 including three directional microphones having a shared front volume 601 and three connected rear volumes 602, 603 and 604. The rear volumes are connected by acoustical resistances 605, 606 in the form of grids. A front sound inlet 607 is acoustically connected to the front volume 601, whereas a rear sound inlet 608 is acoustically connected to the rear volume 604. The grids 605, 606 and the rear volumes 602, 603, 604 are mutually configured in a manner so that the membranes 609, 610, 611 generate cardioid, hypercardioid and dipole polar patterns, respectively. The microphones of FIG. 6 share the same outer housing or cabinet 612.

1-14. (canceled)

15. A microphone module comprising
1) at least two directional microphones having different polar patterns, and
2) a single front sound inlet and a single rear sound inlet.

16. A microphone unit according to claim 15, wherein the at least two directional microphones share a common microphone module housing.

17. A microphone module according to claim 15, wherein the front sound inlet is acoustically connected to a common front volume of the directional microphones.

18. A microphone module according to claim 17, wherein the acoustical connection between the front sound inlet and the common front volume comprises one or more acoustical resistances.

19. A microphone module according to claim 18, wherein the one or more acoustical resistances comprise one or more grids.

20. A microphone module according to claim 15, wherein the front sound inlet is acoustically connected to separated front volumes of the directional microphones.

21. A microphone module according to claim 20, wherein the acoustical connection between the front sound inlet and the separated front volumes comprises one or more acoustical resistances.

22. A microphone module according to claim 21, wherein the one or more acoustical resistances comprise one or more grids.

23. A microphone module according to claim 15, wherein the rear sound inlet is acoustically connected to separated rear volumes of the directional microphones.

24. A microphone module according to claim 23, wherein the acoustical connection between the rear sound inlet and the separated rear volumes comprises one or more acoustical resistances.

25. A microphone module according to claim 24, wherein the one or more acoustical resistances comprise one or more grids.

26. A microphone module according to claim 15, wherein the rear sound inlet is acoustically connected to one of acoustically connected rear volumes of the directional microphones.

27. A microphone module according to claim 26, wherein the acoustical connection between the acoustically connected rear volumes comprises one or more acoustical resistances.

28. A microphone module according to claim 27, wherein the one or more acoustical resistances comprise one or more grids.

29. A microphone module according to claim 26, wherein the acoustical connection between the rear sound inlet and one of the acoustically connected rear volumes comprises one or more acoustical resistances.

30. A microphone module according to claim 29, wherein the one or more acoustical resistances comprise one or more grids.

31. A microphone module according to claim 15, comprising a first directional microphone having an essential cardioid polar pattern, and a second directional microphone having an essential dipole shaped polar pattern.

32. A microphone module according to claim 15, comprising a first directional microphone having an essential cardioid polar pattern, and a second directional microphone having an essential hypercardioid shaped polar pattern.

33. A microphone module according to claim 32, further comprising a third directional microphone having an essential dipole shaped polar pattern.

34. A microphone module according to claim 15, further comprising at least one omni-directional microphone having a separated rear volume.

35. A microphone module according to claim 34, wherein the at least two directional microphones and at least one omni-directional microphone share a common front volume.

36. A hearing aid comprising a microphone module according to claim 15.

37. A method for processing signals in a microphone module according to claim 15, the method comprising the step of combining respective output signals from the directional microphones.
